(19) United States
(12) Patent Application Publication
(10) Pub. No.: US 2018/0159336 A1
(43) Pub. Date: Jun. 7, 2018

(54) Power Supply System Cooperable With Powered Network Cable

(71) Applicant: EATON CORPORATION, CLEVELAND, OH (US)

(72) Inventors: Pavel DEDOUREK, Velké Prilepy (CZ); TOMAS DRABEK, Prague (CZ)

(73) Assignee: EATON CORPORATION, CLEVELAND, OH (US)

(21) Appl. No.: 15/370,013

(22) Filed: Dec. 6, 2016

(51) Int. Cl. H02J 4/00; H04L 12/10; H01R 24/64; H01R 24/66

(52) U.S. Cl. CPC H02J 4/00; H04L 12/10; H01R 2107/00; H01R 24/66; H01R 24/64

(57) ABSTRACT

A power supply system is cooperable with a powered network cable and includes an output apparatus that includes a number of USB connectors and a number of network connectors situated on a support. The power supply system advantageously employs the electrical power that is obtained from the powered network cable to provide power to the USB connectors. The network connectors can either be powered or unpowered or both

### BACKGROUND

### Field

The disclosed and claimed concept relates generally to electronic equipment and, more particularly, to a power supply system that employs a powered network cable to provide power to Universal Serial Bus (USB) connectors.

### Related Art

Numerous types of electronic devices are known in the relevant art. As the related technologies have advanced, people have begun to use greater numbers of electronic devices, and the need for electrical power and connectivity for such devices has correspondingly grown. Many such electronic devices can be powered and connected with other data sources via a Universal Serial Bus (USB) cable that is connected with a USB port on another device. One such type of electronic device that typically is powered via a USB connector is a cellular telephone.

Other electronic devices, typically those that need a network data connection, can be powered using a powered network cable. One example of a powered network cable is a Power over Ethernet (PoE) cable that has been standardized under IEEE 802.3. Typical Ethernet cabling employs eight conductors arranged in four twisted pairs, with one pair being used to communicate data, and with another pair being used to conduct DC current at any of a variety of voltages. One such type of electronic device that needs both power and a network data connection is a video camera.

Numerous types of electrical connectors that provide data connectivity or power or both are known in the relevant art. While such connectors have been generally effective for their intended purposes, they have not been without limitation. Due to the great variety of connectors that exist and that are used in various locations, clutter and confusion have sometimes resulted with numerous wires, connectors, and AC adaptors. Also, electrical power has not always been available at locations where it desirably would exist. Improvements thus would be desirable.

### SUMMARY

An improved power supply system is cooperable with a powered network cable and includes an output apparatus that includes a number of USB connectors and a number of network connectors situated on a support. As employed herein, the expression “a number of” and variations thereof shall refer broadly to any non-zero quantity, including a quantity of one. The power supply system advantageously employs the electrical power that is obtained from the powered network cable to provide power to the USB connectors. The network connectors can either be powered or unpowered or both.

Accordingly, an aspect of the disclosed and claimed concept is to provide a power supply system that is cooperable with a powered network cable and that includes an output apparatus having a number of powered USB connectors and a number of network connectors that may be powered or unpowered or both.

Another aspect of the disclosed and claimed concept is to provide a power supply system having a plate-like support upon which are provided a number of USB connectors and a number of network connectors and that additionally has an input apparatus that is cooperable with a powered network cable to power at least the USB connectors.

As such, an aspect of the disclosed and claimed concept is to provide an improved power supply system structured to power at least some of a plurality of electronic devices that are simultaneously connectable therewith, the power supply system being structured to be mounted to another structure and to be cooperable with a network cable having a plurality of conductors wherein fewer than all of the conductors of the plurality of conductors carry an electrical current. The power supply system can be generally stated as including a support structured to be mounted to the another structure, an input apparatus that can be generally stated as including an electrical diverter situated on the support, the electrical diverter having an electrical connector that is structured to be electrically connected with the fewer than all of the plurality of conductors and to receive at least a portion of the electrical current therefrom, the input apparatus can be generally stated as further including a power converter situated on the support and being electrically connected with the electrical diverter, the power converter being structured to convert the at least portion of the electrical current into DC power at a predetermined voltage, an output apparatus that can be generally stated as including a Universal Serial Bus (USB) connector situated on the support and being electrically connected with the power converter, the USB connector being structured to receive the DC power and to output it to power an electronic device from among the plurality of electronic devices when the USB connector and the electronic device are electrically connected together, and the output apparatus can be generally stated as further including a network connector situated on the support and being electrically connected with at least some of the conductors of the plurality of conductors, the network connector being structured to communicate electronic signals between the network cable and another electronic device from among the plurality of electronic devices when the network connector and the another electronic device are electrically connected together.

### BRIEF DESCRIPTION OF THE DRAWINGS

A further understanding of the disclosed and claimed concept can be gained from the following Description when read in conjunction with the accompanying drawings in which:

FIG. 1 is a front elevational view of an improved power supply system in accordance with the disclosed and claimed concept; and

FIG. 2 is a side view of the power supply system of FIG. 1 mounted to another structure and connected with a powered network cable and simultaneously being connectable with a plurality of electronic devices.

Similar numerals refer to similar parts throughout the specification.

### DESCRIPTION

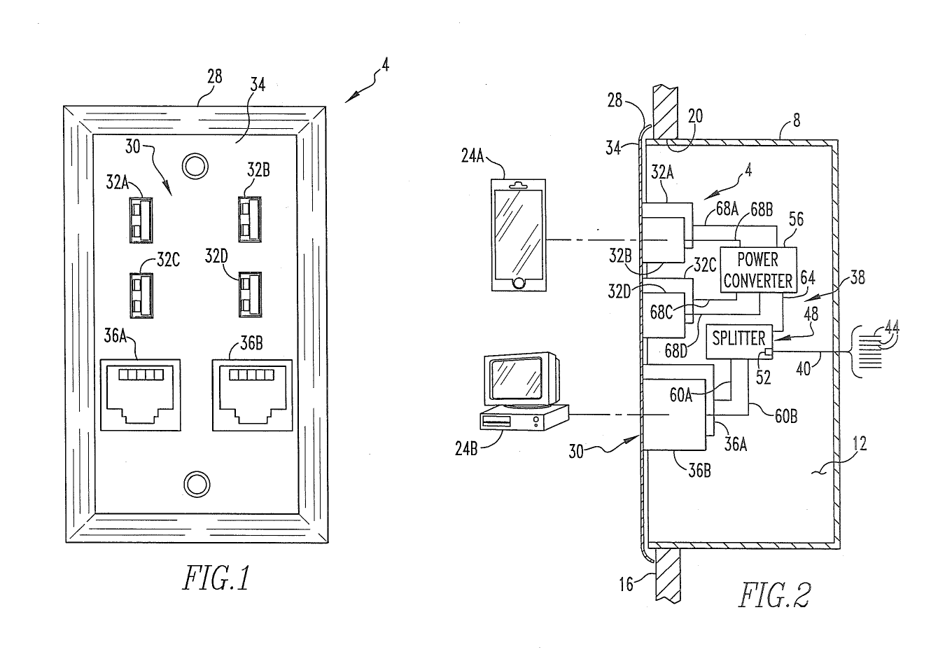

An improved power supply system 4 is depicted in FIGS. 1 and 2. In the depicted exemplary embodiment, the power supply system 4 is mountable to another structure which is depicted herein as being an electrical box 8 having a cavity 12 formed therein. The electrical box 8 is depicted in FIG. 2 as being mounted on a wall 16 within an opening 20 that is formed in the wall 16. As will be set forth in greater detail below, the power supply system 4 is simultaneously electrically connectable with a plurality of electronic devices that may be collectively or individually referred to herein with the numeral 24, and two examples of which are indicated in FIG. 2 at the numerals 24A and 24B. The exemplary electronic device 24A is a cellular telephone that is exemplary of any one or more of a variety of USB-powered electronic devices that are connectable with the power supply system 4.

The exemplary electronic device 24B is a computer that is exemplary of any of a wide variety of devices that require a network connection or a powered network connection, or the like, and can be electrically connected with the power supply system 4. By way of example, the computer 24B typically needs only a network connection since it would be otherwise powered via an AC electrical connection. On the other hand, a networked video camera is an example of a device that obtains power through a powered network connection, and such a networked video camera is another example of the electronic device 24B. As noted above, a plurality of the electronic devices 24 can be simultaneously electrically connected with the power supply system 4, with any one or more receiving electrical power or data connectivity or both from the power supply system 4.

The power supply system 4 can be said to include a support in the exemplary form of a plate 28 which has the appearance, at least in part, of a conventional electrical wall plate. The power supply system 4 further includes an output apparatus 30. The output apparatus 30 in the depicted exemplary embodiment includes four USB connectors (female) that are indicated at the numerals 32A, 32B, 32C, and 32D, and which can be collectively or individually referred to herein with the numeral 32. The output apparatus 30 further includes a pair of network connectors 36A and 36B that can be collectively or individually referred to herein with the numeral 36 and which in the depicted exemplary embodiment are RJ45 connectors. Not only is the output apparatus 30 mounted on the plate 28, but all of the USB connectors 32 and all of the network connectors 36 open onto a front face 34 of the plate 28.

The power supply system 4 further includes an input apparatus 38 that is situated on the plate 28 and that is electrically connected with and interfaces with a network cable 40. The network cable 40 in the depicted exemplary embodiment is a Power over Ethernet (PoE) cable having eight conductors that are indicated generally at the numeral 44. As is generally understood in the relevant art, a pair of the conductors 44 are used to communicate data, and a different pair of the conductors 44 are used to conduct DC current. Some of the conductors 44 may remain unused in a given application.

The aforementioned input apparatus 38 can be said to include an electrical diverter in the form of a splitter 48 having an electrical connector 52, and further includes a power converter 56. The splitter 48 and the power converter 56 are both situated on the plate 28 on a surface opposite the front face 34. The electrical connector 52 is electrically connected with the network cable 40 and can be any of a wide variety of connectors, such as an RJ45 connector or other appropriate connector. Alternatively, the electrical connector 52 can be in the form of a tap that electrically connects only with the pair of conductors 44 that are carrying the DC current. In this regard, it is understood that fewer than all of the conductors 44 carry current, it being reiterated that at least some of the conductors 44 carry data. Other variations will be apparent.

The input apparatus 38 further includes a pair of first cables 60A and 60B which may be collectively or individually referred to herein with the numeral 60. The first cable 60A extends between the splitter 48 and the network connector 36A, and the first cable 60B extends between the splitter 48 and the network connector 36B. The input apparatus 38 further includes a second cable 64 that is electrically connected between the splitter 48 and the power converter 56. The input apparatus 38 additionally includes a set of third cables 68A, 68B, 68C, and 68D, which may be collectively or individually referred to herein with the numeral 68, and which are electrically connected between the power converter 56 and the USB connectors 32A, 32B, 32C, and 32D, respectively.

The splitter 48 receives a portion of the DC current carried by the network cable 40 and conducts that portion of the DC power via the second cable 64 to the power converter 56. The power converter 56 is a DC-to-DC converter which converts the incoming DC current, which can be at any of a variety of voltage values, into DC current at five (5) volts, which is suited for USB output. Any of a wide variety of known power conversion devices can be employed as the power converter 56. The power converter then supplies five volts DC via the third cables 68 to the USB connectors 32. The DC power provided thereby to the USB connectors 32 is usable to power any one or more of the electronic devices 24A that are simultaneously connectable with one or more of the USB connectors 32.

The other portion of the DC current from the network cable 40, i.e., the portion of the DC current that is not communicated from the splitter 48 to the power converter 56, is conducted via the first cables 60 to the network connectors 36. The exemplary first cables 60 each include eight conductors, two of which carry the aforementioned DC power from the network cable 40 to the network connectors 36, and another pair of which carry data from the network cable 40 to the network connectors 36. In such a scenario, four of the conductors of each of the first cables 60 are unused. In a second scenario, either or both of the first cables 60 may be configured to communicate only data to the network connectors 36. In a third scenario, either or both of the first cables 60 may be configured to conduct only DC current to the network connectors 36. Any one or more of the three aforementioned scenarios can be implemented on either or both of the network connectors 36.

While the power supply system 4 is depicted as including four of the USB connectors 32 and two of the network connectors 36, it is understood that any greater or lesser number of such connectors can be provided without departing from the spirit of the disclosed concept. Moreover, the exemplary USB connectors 32 are depicted as being female USB A-type connectors, but they could be of other USB configurations without departing from the spirit of the instant disclosure. Furthermore, it is understood that other electrical connectors could take the place of any one or more of the USB connectors 32 or the network connectors 36 or both, by way of example.

It thus can be seen that the powered network cable 40 can be used by the power supply system 4 to provide electrical power to the USB connectors 32 and, if desired, to either or both of the network connectors 36. Advantageously, therefore, the USB connectors 32 can be provided in a location that does not necessarily have electrical power available, so long as the powered network cable 40 is available. In this regard, it is understood that Ethernet cabling is widely installed throughout parts of the world. While fewer than all of such Ethernet cabling is powered Ethernet cabling, it is understood that such unpowered Ethernet cabling could be converted to Power over Ethernet cabling by applying DC power to a pair of its conductors in a known fashion. In order to do so, a conventional Power over Ethernet power source could be provided, such as in a basement or other appropriate location where electrical power is available, and such power can be applied in a known fashion to a pair of the conductors of the existing Ethernet cabling. The power supply system 4 of the disclosed and claimed concept thus can be advantageously implemented generally anywhere Ethernet or other appropriate network cabling is provided if the network cabling is upgraded to Power over Ethernet or other powered configuration by electrically connecting an appropriate Power over Ethernet power source or other such electrical converter to an appropriate pair of conductors of the network cable.

The power supply system 4 thus advantageously provides electrical power or network connectivity or both to a plurality of electronic devices 24 that are simultaneously connected therewith. The power supply system 4 thus enables a large number of electrical devices 24 to meet their operational needs in a single location. Other advantages will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A power supply system structured to power at least some of a plurality of electronic devices that are simultaneously connectable therewith, the power supply system being structured to be mounted to another structure and to be cooperable with a network cable having a plurality of conductors wherein fewer than all of the conductors of the plurality of conductors carry an electrical current, the power supply system comprising:
a support structured to be mounted to the another structure;
an input apparatus comprising an electrical diverter situated on the support, the electrical diverter having an electrical connector that is structured to be electrically connected with the fewer than all of the plurality of conductors and to receive at least a portion of the electrical current therefrom;
the input apparatus further comprising a power converter situated on the support and being electrically connected with the electrical diverter, the power converter being structured to convert the at least portion of the electrical current into DC power at a predetermined voltage;
an output apparatus comprising a Universal Serial Bus (USB) connector situated on the support and being electrically connected with the power converter, the USB connector being structured to receive the DC power and to output it to power an electronic device from among the plurality of electronic devices when the USB connector and the electronic device are electrically connected together; and
the output apparatus further comprising a network connector situated on the support and being electrically connected with at least some of the conductors of the plurality of conductors, the network connector being structured to communicate electronic signals between the network cable and another electronic device from among the plurality of electronic devices when the network connector and the another electronic device are electrically connected together.

2. The power supply system of claim 1 wherein the electrical diverter is a splitter, and wherein the network connector is structured to receive another portion of the electrical current and to output it to power the another electronic device when the network connector and the another electronic device are electrically connected together.

3. The power supply system of claim 2 wherein the output apparatus comprises another network connector situated on the support and being electrically connected with at least a portion of the conductors of the plurality of conductors.

4. The power supply system of claim 1 wherein the support is a plate, and wherein the power supply system is structured to be at least partially received in a cavity formed in the another structure.

5. The power supply system of claim 1 wherein the fewer than all of the plurality of conductors with which the electrical diverter is structured to be electrically connected comprise at least a portion of a Power over Ethernet (PoE) cable.
